(19) United States
(12) Patent Application Publication
(10) Pub. No.: US 2017/0101086 A1
(43) Pub. Date: Apr. 13, 2017

(54) ENGINE STOPPING SYSTEM

(71) Applicant: TOYOTA JIDOSHA KABUSHIKI KAISHA, Toyota-shi, Aichi-ken (JP)

(72) Inventor: Yasuhiro OSHIUMI, Gotemba-shi, Shizuoka-ken (JP)

(73) Assignee: TOYOTA JIDOSHA KABUSHIKI KAISHA, Toyota-shi, Aichi-ken (JP)

(21) Appl. No.: 15/128,237

(22) PCT Filed: Feb. 26, 2015
(86) PCT No.: PCT/JP2015/056444

§ 371 Date: Sep. 22, 2016

(30) Foreign Application Priority Data
Mar. 25, 2014 (JP) 2014-062087

(51) Int. Cl. B60W 20/40; B60W 10/06; B60K 6/387; B60W 30/20; B60K 6/445; B60K 6/365; B60W 10/02; B60W 10/08

(52) U.S. Cl. CPC B60W 20/40; B60W 10/02; B60W 10/06; B60W 10/08; B60W 30/20; B60K 6/445; B60K 6/365; B60K 6/387; B60W 2030/206; B60W 2510/0208; B60W 2510/0241; B60W 2510/0638; B60W 2510/0666; B60W 2510/081; B60W 2520/10; B60W 2710/021; B60W 2710/027; B60W 2710/0644; B60W 2710/083; B60W 2710/248; B60Y 2200/92; B60Y 2300/205; Y10S 903/93; Y10S 903/946; Y10S 903/914; Y10S 903/91

(57) ABSTRACT

An engine stopping system for reducing electric consumption by interrupting power supply to a motor during disengagement of a clutch is provided. The engine stopping system is applied to a vehicle in which the clutch is interposed between an engine and a power distribution device. The engine stopping system is configured to interrupt power supply to the motor while bringing the clutch into disengagement, when an input speed Nᵢₙ falls below a threshold value α, under conditions that the engine does not generate power during engagement of the clutch, and that the motor generates electricity utilizing an inertia torque of the engine while controlling an output torque of the motor to lower the engine speed.

### TECHNICAL FIELD

This invention relates to an engine stopping system for a hybrid vehicle in which a power of an engine is distributed to a motor side and to a driving wheel side through a power distribution device, and in which the engine is disconnected from the power distribution device by bringing a clutch into disengagement.

### BACKGROUND ART

For example, JP-A-2012-224244 describes a 2-motor split type hybrid vehicle provided with a planetary gear unit having a sun gear, a carrier and a ring gear. In the hybrid vehicle taught by JP-A-2012-224244, the sun gear is coupled to a first motor/generator, the carrier is coupled to the engine through a clutch, and the ring gear serves as an output element to deliver torque to drive wheels. Torque of a second motor/generator is added to the torque delivered from the ring gear to the drive wheels, and the engine is disconnected from the power distribution device by bringing the clutch into disengagement.

According to the teachings of JP-A-2012-224244, when engine stop conditions are satisfied, at least fuel injection and ignition is stopped, and then torque of the first motor/generator is controlled in a manner such that the engine speed is lowered. Consequently, the first motor/generator regenerates electric power utilizing an inertial torque of the engine. When a rotational speed of the first motor/generator falls within a predetermined speed range including zero, the clutch is brought into disengagement.

### SUMMARY OF INVENTION

### Technical Problem

However, according to the teachings of JP-A-2012-224244, a feedback control is executed after disengagement of the clutch until the rotational speed of the first motor/generator is reduced to zero. This means that the electric power may be consumed during execution of the feedback control.

The present invention has been conceived noting the foregoing technical problem, and it is therefore an object of the present invention is to provide an engine stopping system for reducing electric consumption when stopping the engine, by stopping power distribution to a motor while bringing a clutch into disengagement.

### Solution to Problem

The engine stopping system of the present invention is applied to a hybrid vehicle comprising: an engine; a motor having generating function; a power distribution device that performs a differential action among a plurality of rotary elements; and a clutch that selectively connects and disconnects the engine to/from the power distribution device. In the power distribution device, specifically, a first rotary element is joined to the motor to be rotated integrally therewith, a second rotary element is joined to the engine through the clutch, and a third rotary element serves as an output element to deliver torque to drive wheels. The engine stopping system is configured to vary an engine speed by controlling a torque of the motor during engagement of the clutch. In order to achieve the above-explained objective, according to the present invention, the engine stopping system is further configured to interrupt power supply to the motor while bringing the clutch into disengagement, when the engine speed falls below a predetermined threshold value greater than zero under conditions that the engine does not generate power during engagement of the clutch, and that the motor generates electricity utilizing an inertia torque of the engine while controlling an output torque of the motor in a manner such that the engine speed is lowered.

If the vehicle speed is higher than a predetermined speed and the motor is rotated in a same direction as a rotational direction of the engine, the threshold value of the engine speed is set to a value calculated based on the vehicle speed, and a lower limit speed of a speed range of the motor where a generation amount of the motor exceeds an electric consumption to generate electricity. Here, the lower limit speed of the motor speed range is greater than zero.

By contrast, if the vehicle speed is lower than the predetermined speed, the threshold value of the engine speed is set to an upper limit value of a speed range of the engine where the engine resonates with a powertrain.

For example, a friction clutch may be used as the claimed clutch. In this case, the engine stopping system can reduce a torque capacity of the clutch to an extent not to cause a slippage, before the engine speed falls below the threshold value under conditions that the engine does not generate power during engagement of the clutch.

In addition, the engine stopping system interrupts the power supply to the motor after the clutch starts slipping.

Instead, it is also possible to interrupt the power supply to the motor simultaneously with bringing the clutch into disengagement.

### Advantageous Effects of Invention

Thus, according to the present invention, when the engine speed falls below the predetermined threshold value greater than zero under conditions that the motor generates electricity utilizing the inertia torque of the engine while controlling the motor to lower the engine speed. Therefore, electric consumption of the motor can be reduced.

For example, if the vehicle speed is higher than the threshold value, the power supply to the motor is interrupted before the electric consumption of the motor exceeds the generation amount. Therefore, the motor can be prevented from consuming electricity when stopping the engine.

By contrast, if the vehicle speed is lower than the threshold value, the clutch is brought into disengagement before the engine speed enters into the range where the engine resonates with the powertrain.

In addition, the torque capacity of the clutch is reduced to the extent not to cause a slippage prior to bringing the clutch into disengagement. Therefore, the clutch is allowed to be brought into complete disengagement promptly.

Further, the power supply to the motor can be interrupted before the completion of disengagement of the clutch.

### BRIEF DESCRIPTION OF DRAWINGS

FIG. 1 is a flowchart showing one example of the engine stopping control according to the present invention.

FIG. 2 is a time chart showing a resonance range.

FIG. 3 is a time chart showing a generation range.

FIG. 4 is a nomographic diagram showing a threshold value of the vehicle speed determined based on an upper limit speed of the resonance range and a lower limit speed of the generation range.

FIG. 5 is a flowchart showing a procedure for determining a threshold value of an input speed used at step S3 in FIG. 1.

FIG. 6 is a nomographic diagram showing a situation in which a speed lowering control is executed at the vehicle speed lower than the threshold value.

FIG. 7 is a nomographic diagram showing a situation in which the speed lowering control is executed at the vehicle speed higher than the threshold value.

FIG. 8 is a nomographic diagram showing a threshold of the input speed determined based on the lower limit speed of the generation range and the vehicle speed.

FIG. 9 is a time chart showing a situation under execution of the engine stopping control shown in FIG. 1.

FIG. 10 is a skeleton diagram showing one example of a powertrain of the hybrid vehicle to which the present invention is applied.

FIG. 11(a) is a nomographic diagram showing a situation of the hybrid vehicle propelled under HV mode. FIG. 11(b) is a nomographic diagram showing a situation in which the engine speed is lowered by carrying out the engine stopping control.

FIG. 12 is a skeleton diagram showing another example of a powertrain of the hybrid vehicle to which the present invention is applied.

### DESCRIPTION OF EMBODIMENTS

Hereinafter, preferred examples of the engine stopping system will be explained with reference to the accompanying drawings. According to the preferred examples to be explained, the engine stopping system is applied to a two-motor split type hybrid vehicle having a clutch adapted to selectively disconnect an engine from a power distribution device. When stopping the engine, the engine stopping system brings the clutch into disengagement and cuts electricity to one of motor/generators.

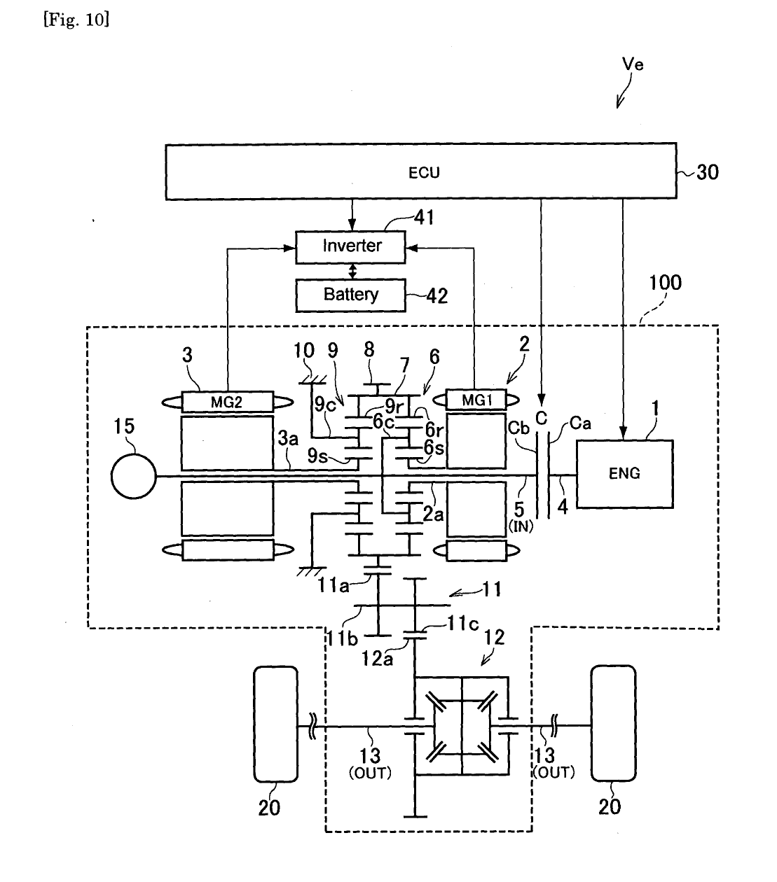

Referring now to FIG. 10, there is shown a structure of the hybrid vehicle to which the engine stopping system is applied. As shown in FIG. 10, the hybrid vehicle Ve is comprised of a two-motor split type powertrain 100. In order to control the powertrain 100, the hybrid vehicle is provided with an electronic control unit (abbreviated as “ECU” hereinafter) 30 serving as a controller of the engine stopping system.

A prime mover of the powertrain 100 includes an internal combustion engine (abbreviated as “ENG” in FIG. 10) 1, a first motor/generator 2 (abbreviated as “MG1” in FIG. 10), and a second motor/generator 3 (abbreviated as “MG2” in FIG. 10).

For example, a conventional gasoline engine may be used as the engine 1, and a permanent magnet type synchronous motor may be used as the motor/generators 2 and 3 respectively. Those engine 1 and the motor/generators 2 and 3 are also electrically controlled by the ECU 30. In the following descriptions, the motor/generators 2 and 3 will simply be called as “the motor 2” and “the motor 3” for the sake of convenience.

In the powertrain 100, a power of the engine 1 is delivered to a power distribution device 6 via an input shaft 5, and further distributed to the first motor 2 side and drive wheels 20 side through the power distribution device 6. A torque T_{mg2} of the second motor 3 is added to a torque delivered from the power distribution device 6 to the drive wheels 20. That is, the power of the engine 1 is partially converted into an electric power by the first motor 2, and then converted into a mechanical power again by the second motor 3 to be delivered to the drive wheels 20.

In order to disconnect the engine 1 from the power distribution device 6 when stopping the engine 1, a friction clutch C is disposed therebetween. When the engine 1 is restarted, the friction clutch C is brought into engagement to deliver the power of the engine 1 to the power distribution device 6.

Specifically, the friction clutch C is a conventional clutch having a pair of frictional engagement elements. As shown in FIG. 10, one of the engagement elements Ca is coupled to a crankshaft 4 of the engine 1 to be rotated therewith, and other engagement element Cb is coupled to the input shaft 5 to be rotated therewith. In the powertrain 100, therefore, torque transmission between the engine 1 and the power distribution device 6 is cut off by bringing the friction clutch C into complete disengagement. By contrast, torque transmission between the engine 1 and the power distribution device 6 is enabled by bringing the friction clutch into complete engagement.

Given that the friction clutch C is in complete disengagement, the engagement elements Ca and Cb are isolated from each other. By contrast, given that the friction clutch C is in complete engagement, the engagement elements Ca and Cb are engaged to each other without causing a slippage. The friction clutch C may also be engaged while causing a slippage between the engagement elements Ca and Cb. In the following descriptions, the friction clutch C will simply be called the “clutch C” for the sake of convenience.

The power distribution device 6 is adapted to perform a differential action among a plurality of rotary elements. To this end, according to the preferred example, a single-pinion planetary gear unit is employed as the power distribution device 6, and the power distribution device 6 is comprised of a sun gear 6s serving as a first rotary element, a carrier 6c serving as a second rotary element, and a ring gear 6r serving as a third rotary element.

The sun gear 6s is an external gear fitted onto the input shaft 5, and the ring gear 6r as an internal gear is arranged concentrically with the sun gear 6s. A plurality of pinion gears are interposed between the sun gear 6s and the ring gear 6r while meshing with those gears, and the pinion gears are supported by the carrier 6c while being allowed to rotate and revolve around the sun gear 6s.

Specifically, the sun gear 6s is joined to a rotor shaft 2a of the first motor 2 to be rotated integrally therewith. Therefore, torque T_{mg1} of the first motor 2 can be distributed to the input shaft 5 side and to the drive wheels 20 side through the power distribution device 6.

The carrier 6c is connected to the engine 1 through the input shaft 5 and the clutch C to serve as an input element of the power distribution device 6. That is, the carrier 6c is allowed to be rotated integrally with the input shaft 5 and the engagement element Cb irrespective of an engagement state of the clutch C. Specifically, given that the clutch C in disengagement, the carrier 6c is rotated relatively to the crankshaft 4. By contrast, given that the clutch C is in engagement, the carrier 6c is rotated integrally with the crankshaft 4.

According to the preferred example, an input member of the powertrain 100 includes the carrier 6c, the input shaft 5, and the engagement element Cb rotated integrally with the carrier 6c. Given that the clutch C is in engagement, the input member further includes the engagement element Ca and the crankshaft 4.

Although not especially illustrated, the input member such as the input shaft 5 is provided with a vibration damper to dampen vibrations of the engine 1 propagated thereto during engagement of the clutch C.

The ring gear 6r serves as an output element of the power distribution device 6 to deliver the torque to the drive wheels 20. To this end, the ring gear 6r is joined to an output shaft 7 to be rotated integrally therewith, and the output shaft 7 is also joined to an output gear 8 as an external gear to be rotated integrally therewith. That is, the output gear 8 serves as an output member of the powertrain 100 to deliver torque to the drive wheels 20. The ring gear 6r, the output shaft 7 and the output gear 8 may be formed integrally.

The output gear 8 is connected to a differential gear unit 12 through a counter gear unit 11. Specifically, the counter gear unit 11 is comprised of a counter driven gear 11a, a countershaft 11b, and a counter drive gear 11c. The counter driven gear 11a is fitted onto the countershaft 11b while meshing with the output gear 8, and the counter drive gear 11c is also fitted onto the countershaft 11b while meshing with a ring gear 12a of the differential gear unit 12. Here, the counter drive gear 11c is diametrically smaller than the counter driven gear 11a. An axle 13 (indicated as “OUT” in FIG. 10) is individually joined to each side of the differential gear unit 12, and the drive wheel 20 is individually fitted onto each axle 13.

In the powertrain 100, the torque T_{mg2} of the second motor 3 is also delivered to the drive wheels 20 through the output gear 8. In order to multiply the torque T_{mg2}, the second motor 3 is connected to the output gear 8 through a reduction gear unit 9. As described, the output gear 8, the output shaft 7, and the ring gear 6r of the power distribution device 6 are rotated integrally so that the torque T_{mg2} can be delivered from the second motor 3 to the ring gear 6r through the reduction gear unit 9.

A single-pinion planetary gear unit is also employed as the reduction gear unit 9. That is, the reduction gear unit 9 is comprised of a sun gear 9s, a carrier 9c and a ring gear 9r. Specifically, the sun gear 9s is joined to the second motor 3 to serve as an input element so that the sun gear 9s is rotated integrally with a rotor shaft 3a of the second motor 3. The carrier 9c is fixed to a fixed member 10 such as a housing to serve as a reaction element, and the ring gear 9r is joined to the output shaft 7 to be rotated integrally with the output shaft 7 and the output gear 8. A gear ratio of the reduction gear unit 9 is set in a manner such that the ring gear 9r is allowed to multiply the torque T_{mg2} of the second motor 3. Here, the ring gear 9r may also be formed integrally with the output shaft 7 and the output gear 8.

For example, when decelerating the hybrid vehicle Ve, the ECU 30 carries out a regeneration control to convert an external mechanical power from the drive wheels 20 into an electric power by the second motor 3. For this purpose, the hybrid vehicle Ve is provided with a battery 42, and electric powers regenerated by the motors 2 and 3 are delivered to the battery 42.

Specifically, the motors 2 and 3 are electrically connected to the battery 42 though an inverter 41 so that the motors 2 and 3 are electrically controlled by the ECU 30 to serve as a motor or a generator depending on the situation. For example, the each motor 2 and 3 is allowed to serve as a motor by delivering electricity stored in the battery 42 thereto. In addition, since the motors 2 and 3 are connected to each other through the inverter 41, the electricity regenerated by the first motor 3 may be delivered directly to the second motor 3 without passing through the battery 42.

The input shaft 5 is joined to an oil pump 15 of a lubrication device so that the oil pump 15 can be driven by rotating the input shaft 5. Thus, as can be seen from FIG. 10, the crankshaft 4 of the engine 1, the input shaft 5, the rotor shaft 2a of the first motor 2, the power distribution device 6, the reduction gear unit 9, and the rotor shaft 3a of the second motor 3 are arranged coaxially in the powertrain 100.

For example, the clutch C is actuated by a not shown hydraulic actuator or an electromagnetic actuator in response to a control signal transmitted from the ECU 30. Therefore, a torque capacity T_{cl-act} of the clutch C can be controlled arbitrarily by controlling an actuation of the actuator by the ECU 30.

The torque capacity T_{cl-act} of the clutch C may be varied continuously from the complete disengagement to the complete engagement of the clutch C. Here, it is to be noted that the torque capacity T_{cl-act} of the clutch C is varied substantially proportional to a hydraulic pressure or a current applied to the clutch C, or to a stroke of the clutch C.

The ECU 30 is comprised mainly of a microcomputer having a memory device, an interface and etc. Specifically, the ECU 30 is configured to carry out a calculation based on incident data and preinstalled data, and to transmit a calculation result in the form of command signal.

For example, a vehicle speed, an opening degree of accelerator, a rotational speed, a state of charge (abbreviated as the “SOC” hereinafter) of the battery 42 and so on are sent to the ECU 30. The rotational speed includes an input speed Nᵢₙ of the input member, a speed N_{mg1} of the first motor 2, and a speed Nₑ of the engine 1 (as will be called the “engine speed Nₑ” hereinafter). Specifically, the input speed Nᵢₙ includes a speed of the carrier 6c of the power distribution device 6, a speed of the input shaft 5, and a speed of the engagement element Cb of the clutch C. Here, given that the clutch C is in the complete engagement, the engine speed Nₑ is equal to the input speed Nᵢₙ.

For example, a map determining a command value of the torque capacity a map determining a target speed to stop the engine 1 automatically, a map determining a command value of the torque T_{mg1} of the first motor 2, a map determining a command value of the torque T_{mg2} of the second motor 3 and so on are preinstalled in the ECU 30. The target speed can include after-mentioned upper limit speed Nₐ of the resonance range A and lower limit speed N_{b} of the generation range B. Optionally, a map determining the resonance range A and a map determining the generation range B may be preinstalled in the ECU 30. In addition, the torque capacity T_{cl-act} of the clutch C with respect to an actuation of the actuator may also be preinstalled in the ECU 30 in the form of map.

The ECU 30 is configured to transmit command signals for controlling the engine 1, the clutch C, and motors 2 and 3 and so on depending on the running condition of the hybrid vehicle Ve. Specifically, the command value of the torque capacity T_{cl-act} of the clutch C is sent to the actuator, and command values of the torques T_{mg1} and T_{mg2} of the motors 2 and 3 are sent to the inverter 41.

A drive mode of the hybrid vehicle Ve can be selected from a hybrid mode (as will be called the “HV” mode hereinafter) where the hybrid vehicle is powered by the engine 1, and a motor mode (as will be called the “EV” mode hereinafter) where the vehicle is propelled by driving the second motor 3 by the electricity from the battery 42 while stopping the engine 1. Specifically, the drive mode of the hybrid vehicle Ve is selected from the HV mode and the EV mode by the ECU 30 to achieve a required drive torque T_{req}, depending on the running condition such as an opening degree of the accelerator, a vehicle speed, an SOC of the battery 42 and so on.

For example, the HV mode may be selected under conditions that an opening degree of the accelerator is relatively large so that the hybrid vehicle Ve is propelled at a relatively high speed. In addition, even if the opening degree of the accelerator is small, the drive mode is shifted to the HV mode when the SOC of the battery 42 falls below a predetermine threshold.

The HV mode includes a drive mode where the hybrid vehicle is powered by both o the engine 1 and the second motor 3, and a drive mode where the hybrid vehicle is powered only by engine 1. Under the HV mode, the clutch C is brought into engagement completely so that the engine speed Nₑ can be controlled by the first motor 2.

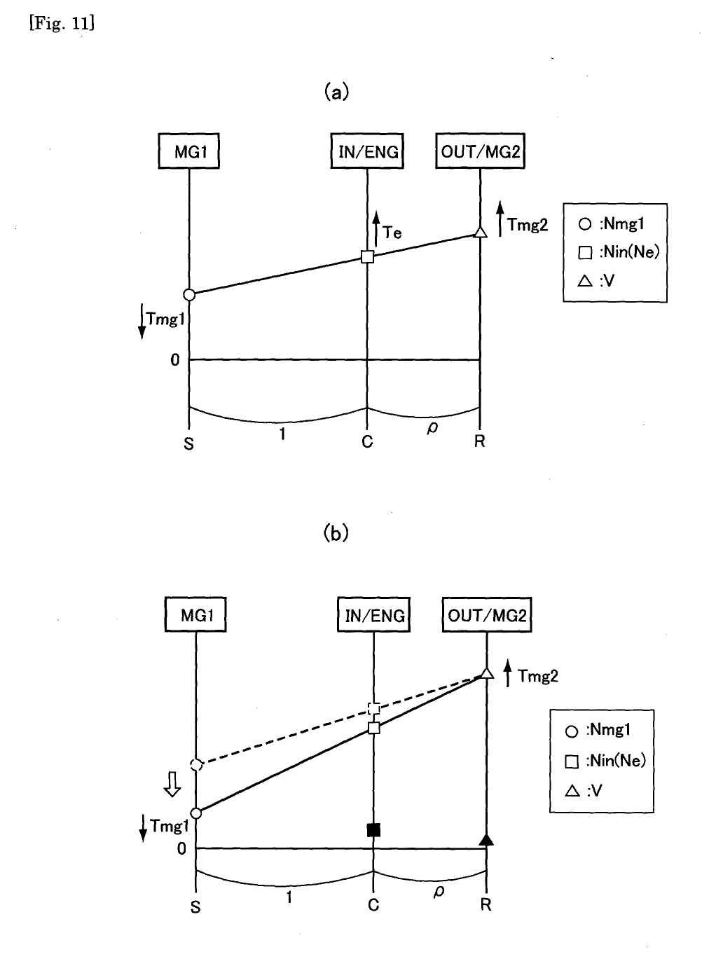

Referring now to FIG. 11, there are shown nomographic diagrams indicating is statuses of the rotary elements of the power distribution device 6 under the HV mode. In FIG. 11, specifically, vertical lines represent a rotational directions and rotational speeds of the sun gear 6s, the carrier 6c and the ring gear 6r respectively, and each clearance between the vertical lines indicates a gear ratio ρ. As described, the sun gear 6s is joined to the first motor 2 (MG1), the carrier 6c is joined to the input member or the engine 1 (IN/ENG), and the ring gear 6r is joined to the output member or the second motor 3 (OUT/MG2).

As shown in FIG. 11(a), under the HV mode, the engine 1 generates the engine torque Tₑ and the second motor 3 generates the torque T_{mg2} in the forward direction. In this situation, the engine speed Nₑ (i.e., the input speed Nᵢₙ) can be varied by controlling the torque T_{mg1} of the first motor 2 depending on the situation.

That is, under the HV mode, the engine 1 is allowed to be operated at an operating point where fuel efficiency is optimized by controlling the engine speed Nₑ by the first motor 2. Here, it is to be noted that the operating point of the engine 1 is governed by the engine speed Nₑ and the engine torque Tₑ. To this end, a map determining the operating point based on the vehicle speed and the opening degree of the accelerator is preinstalled in the ECU 30, and the operating point of the engine 1 is determined based on incident data about the vehicle speed and the opening degree of the accelerator with reference to the map. Basically, the operating point of the engine 1 is determined on an optimum fuel curve, and the first motor 2 is controlled in a manner such that the engine 1 is operated at the determined operating point.

Given that a gasoline engine is employed as the engine 1, the ECU 30 controls an opening degree of a throttle valve, a fuel supply, an interruption of fuel supply, an ignition timing, a cessation of ignition etc. That is, the ECU 30 is configured to carry out a various kinds of engine controls depending on the situation. For example, the ECU carries out a stopping control of the engine 1 to reduce fuel consumption. In addition, the ECU 30 also carries out an engine starting control, an engine torque control and an engine restarting control.

Specifically, the engine stopping control is carried out under the condition that the hybrid vehicle Ve is in operation so as to stop fuel supply to the engine 1 and ignition of the engine 1.

For example, the engine stopping control is carried out when the hybrid vehicle Ve propelled under the HV mode waits at a traffic light to stop the engine 1 temporarily (i.e., an idle stop control). The engine stopping control includes a fuel cut-off control to be carried out when an accelerator pedal is returned at a vehicle speed higher than a predetermined speed. Under the fuel cut-off control, fuel supply to the engine 1 is stopped until the engine speed is lowered to a self-sustaining speed (i.e., to an idling speed).

Specifically, the engine stopping control is carried out on the occasion of shifting the drive mode from the HV mode to the EV mode in order not to consume fuel.

For example, the EV mode can be selected under conditions where an SOC of the battery 42 is sufficient, and an opening degree of the accelerator is relatively small. It is to be noted that the EV mode includes a dual-motor mode where the hybrid vehicle is powered by both motors 2 and 3, and a single-motor mode where the hybrid vehicle is powered only by the second motor 3.

Under the dual-motor mode, if a positive torque is demanded, the first motor 2 generates the torque T_{mg1} in the negative direction and the second motor 3 generates the torque T_{mg2} in the positive direction. In this situation, the torque T_{mg1} of the first motor 2 serves as a drive torque to rotate the axle 13 in the positive direction. In addition, the clutch C is brought into complete engagement and the engine 1 is not rotated.

If a positive torque is demanded under the single motor mode, the first motor 2 is stopped and the second motor 3 generates the torque T_{mg2} in the positive direction to achieve the required torque. In this case, the first motor 2 may be kept activated but the speed N_{mg1} and the torque T_{mg1} thereof are reduced to zero.

The single-motor mode may be categorized into a first EV mode where the clutch C is in complete engagement and a second EV mode where the clutch C is in complete disengagement. Under the first EV mode, specifically, the engine 1 is connected to the power distribution device 6. By contrast, under the second EV mode, the engine 1 is disconnected from the power distribution device 6.

Since the clutch C is in complete engagement under the first EV mode, the engine speed Nₑ is equal to the input speed Nᵢₙ. In this situation, since the first motor 2 is stopped but the input member is rotated, the stopping engine 1 is rotated passively.

For example, if the engine is expected to be restarted under the EV mode, the first EV mode is selected. Under the first EV mode, however, a power loss would be caused by rotating the engine 1 passively. In order to avoid such power loss, the drive mode can be shifted to the second EV mode by bringing the clutch C into disengagement if the situation allows. For example, the second EV mode can be selected if an SOC of the battery 42 is sufficient and the required torque T_{req} can be achieved only by the motors 2 and 3. Under the second EV mode, therefore, the engine 1 is disconnected from the power distribution device 6 while being stopped.

Since the clutch C is in complete disengagement, the engine speed Nₑ is different from the input speed Nᵢₙ under the second EV mode. Specifically, the engine speed Nₑ is reduced to zero, and the input speed Nᵢₙ is higher than the engine speed Nₑ in the forward direction.

When a predetermined condition to restart the engine 1 is satisfied under the second EV mode, the drive mode is shifted from the second EV mode to the HV mode by restarting the engine 1 while bringing the clutch C in a slipping manner.

For example, the starting condition of the engine 1 is satisfied in case the accelerator pedal is depressed to require the larger driving force, and in case the SOC of the battery 42 is insufficient to achieve the required drive torque T_{req}.

The ECU 30 is configured to carry out a motor torque control and an interruption control of power supply depending on the running condition of the hybrid vehicle Ve. Specifically, a rotational direction of the rotor shaft of the motor 2 or 3 is altered between the forward and counter directions by the motor torque control. For example, the motor is allowed to serve as a motor by increasing a rotational speed of the rotor shaft. By contrast, the motor is allowed to serve as a motor by decreasing a rotational speed of the rotor shaft.

In the following descriptions, the rotational directions of the motor 2 or 3 will be called as the “forward direction” and the “counter direction”. Specifically, definition of the “forward direction” is a rotational direction of the engine 1, and definition of the counter direction is a rotational direction opposite to the rotational direction of the engine 1. Additionally, in the following descriptions, a torque in the forward direction will be called as the “positive torque”, and a torque in the counter direction will be called as the “negative torque”.

As described, the engine 1 is connected to the first motor 2 through the power distribution device 6 so that the engine speed Nₑ can be varied by controlling the torque of the first motor 2 given that the clutch C is in engagement. To this end, specifically, the torque T_{mg1} of the first motor 2 is controlled to change the speed N_{mg1} thereof, and consequently the engine speed Nₑ is changed.

Given that the clutch C is in engagement, the engine speed Nₑ can not only be lowered but also be raised by controlling the torque T_{mg1} of the first motor 2. Specifically, such lowering control of the engine speed Nₑ is carried out on the occasion of stopping the engine 1.

Referring back to FIG. 11, FIG. 11(a) indicates statuses of the rotary elements of the power distribution device 6 before starting the lowering control, and FIG. 11(b) indicates statuses of the rotary elements of the power distribution device 6 after carrying out the lowering control.

In the situation shown in FIG. 11(b), the lowing control of the engine speed Nₑ is in execution and the engine torque Tₑ is reduced to zero. As indicated by the arrow in FIG. 11(b), the torque T_{mg1} of the first motor 2 is negative during execution of the lowering control to reduce the engine speed Nₑ. In this situation, inertia energy of the engine 1 is converted into electric power, that is, regeneration of the power can also be achieved by controlling the motor torque.

By contrast, the engine speed Nₑ may also be lowered even if the first motor 2 is rotated in the counter direction by controlling the torque T_{mg1}. In this case, specifically, the first motor 2 is rotated as a motor in the counter direction while consuming electricity to generate the negative torque.

The interruption control of power distribution to the first motor 2 is carried out depending on a running condition of the hybrid vehicle Ve to reduce electricity consumption (even if the vehicle Ve is stopping). Such interruption control of power distribution to the first motor 2 may be carried out together with the engine stopping control.

Specifically, power supply from the inverter 41 or the battery 42 to the first motor 2 is interrupted to stop the first motor 2. In this situation, the first motor 2 generates neither a drive torque nor an electric power without consuming electricity. When a predetermined condition to restart the first motor 2 is satisfied, the ECU 30 carries out a restarting control of the first motor 2.

When stopping the engine 1, the ECU 30 also controls the torque capacity T_{cl-act} of the clutch C. To this end, specifically, the ECU 30 determines a torque command to the clutch C with reference to a map. Consequently, the torque command thus determined is transmitted to the actuator so that the actuator is actuated in response to the torque command. As described, a friction clutch is used as the clutch C and the torque capacity thereof can be varied gradually. In this situation, however, a response delay of the clutch C arises from the structure thereof.

For example, given that a hydraulic frictional clutch is used as the clutch C, an actuation of the actuator would be delayed behind the transmission of the torque command. That is, change in the torque capacity T_{cl-act} of the clutch C is delayed behind the transmission of the torque command. Consequently, an actual torque capacity T_{cl-act} may temporarily differ from the torque command. In order to avoid such a disadvantage, according to the preferred example, the ECU 30 carries out a control to reduce influence of such response delay of the clutch C.

According to the preferred example, specifically, the torque capacity T_{cl-act} of the clutch C is reduced to a target torque capacity T_{cl}′ before commencement of disengagement of the clutch C during lowering the engine speed Nₑ by controlling the torque T_{mg1} of the first motor 2. To this end, the target torque capacity T_{cl}′ of the clutch C is determined in a manner not to cause a slippage of the clutch C. For example, the target torque capacity T_{cl}′ can be calculated using the following formula 1.

$$T c {l}^{′} = ( T m g {1}^{′} - I mg {1}^{′} \cdot \dot{ω} mg 1 ) \cdot \frac{1 + ρ}{ρ} \cdot S F \qquad [ Formula 1 ]$$

In the above formula 1, T_{mg1}′ is a torque of the first motor 2 determined based on a lowering rate of the engine speed Nₑ and an upper limit value of the electric power that can be stored into the battery 42 and so on, I_{mg1}*(dω_{mg1}/dt) is an inertia torque of the first motor 2, ρ is a gear ratio of the planetary gear unit serving as the power distribution device 6, and SF is a factor of safety to compensate the response delay of the clutch C behind the torque command.

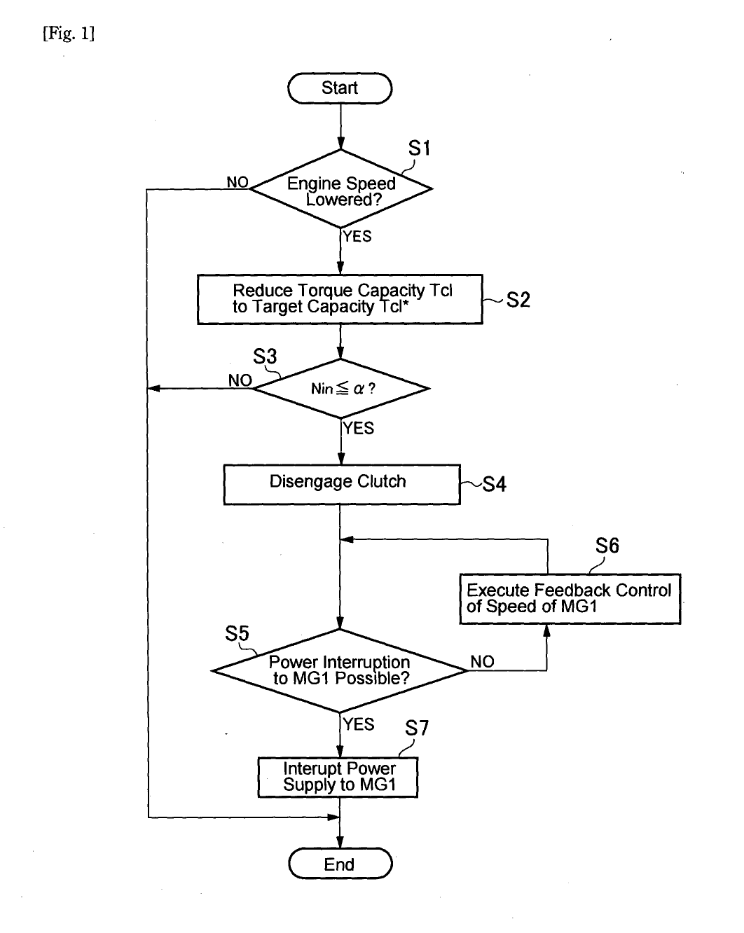

Next, here will be explained the engine stopping control according to the preferred example with reference to FIG. 1. At step S1, it is determined whether or not the engine speed Nₑ is being lowered by controlling the torque T_{mg1} of the first motor 2. Specifically, it is determined whether or not the lowering control of the engine speed Nₑ is in execution after stopping a power generation of the engine 1.

If the lowering control of the engine speed Nₑ is in execution while rotating the first motor 2 in the forward direction, the answer of step S1 will be YES. In this case, at step S1, it is determined whether or not the regeneration of inertia force of the engine 1 is being carried out by the first motor 2 during execution of the engine stopping control. By contrast, if the lowering control of the engine speed Nₑ is not executed so that the answer of step S1 is NO, the routine is ended.

If the lowering control of the engine speed Nₑ is in execution so that the answer of step S1 is YES, the torque capacity T_{cl-act} of the clutch C is reduced to the target torque capacity T_{cl}′ (at step S2). That is, if the answer of step S1 is YES, this means that the clutch C is in engagement. Therefore, the torque capacity T_{cl-act} of the clutch C is reduced to the target torque capacity T_{cl}′ at which the clutch C will not start slipping. For this reason, the clutch C is allowed to be promptly brought into disengagement completely at a later step.

Then, it is determined whether or not the input speed Nᵢₙ is equal to or lower than a predetermined threshold value α (at step S3). To this end, the threshold α to be compared with the input speed Nᵢₙ is determined in accordance with a running condition of the hybrid vehicle Ve by the procedure to be explained later.

If the input speed Nᵢₙ is higher than the threshold α so that the answer of step S3 is NO, the routine is ended.

By contrast, if the input speed Nᵢₙ is lower than the threshold α so that the answer of step S3 is YES, the clutch C is brought into disengagement (at step S4). At step S4, specifically, the ECU 30 transmits a control signal for bringing the clutch C into complete disengagement so that the torque capacity T_{cl-act} of the clutch C starts being reduced from the target torque capacity T_{cl}′. Consequently, the clutch C starts slipping and the slippage of the clutch C is continued until the clutch C is brought into disengagement completely.

In this situation, since the torque capacity T_{cl-act} of the clutch C is reduced in advance to the target torque capacity T_{cl}′ at step S2, the clutch C is allowed to be promptly brought into the complete disengagement. That is, the structural response delay of the clutch C can be reduced.

Then, it is determined whether or not situation allows to interrupt power supply to the first motor 2 (at step S5). At step S5, specifically, it is determined whether or not a level of system voltage of the first motor 2 raised by the inverter 41 is possible level to stop the first motor 2 normally. Basically, a reverse voltage of motor is proportionate to a rotational speed. At step S5, therefore, the ECU 30 determines whether or not the speed N_{mg1} of the first motor 2 rotating in the forward direction is lower than a possible speed to stop the first motor 2.

If the situation does not allow to interrupt power supply to the first motor 2 so that the answer of step S5 is NO, the routine advances to step S6 to carry out a feedback control of the speed N_{mg1} of the first motor 2, and returns to step S5.

By contrast, if it is possible to interrupt the power supply to the first motor 2 so that the answer of step S5 is YES, the power supply to the first motor 2 is interrupted (at step S7).

Here, it is to be noted that an order of functional blocks in the routine shown in FIG. 1 should not be limited to that shown in FIG. 1. For example, the functional blocks of steps S4 and S7 may be commenced simultaneously. That is, the clutch may also be brought into the complete disengagement simultaneously with interrupting the power supply to the first motor 2.

Here will be explained a procedures of determining the threshold α used as a parameter to be compared with the input speed Nᵢₙ (or the engine speed Nₑ) during engagement of the clutch C. Specifically, the threshold α is determined based on a vehicle speed V.

A value of the threshold α is differentiated between situations where the vehicle speed V is higher than another threshold β of the vehicle speed, and where the vehicle speed V is lower than another threshold β of the vehicle speed. Thus, another threshold β of the vehicle speed is used to determine the threshold α of the input speed Nᵢₙ.

Another threshold β of the vehicle speed is determined taking account of the resonance range A and the generation range B. Specifically, the resonance range A is a range of the engine speed Nₑ where resonance occurs during engagement of the clutch C in the downstream of the clutch C. Such resonance is caused by propagation of vibrations of the engine 1 during engagement of the clutch C. On the other hand, the generation range B is a range of the speed N_{mg1} of the first motor 2 where an electric generation of the first motor 2 exceeds an electric consumption of the first motor 2 during execution of the lowering control to reduce the engine speed Nₑ.

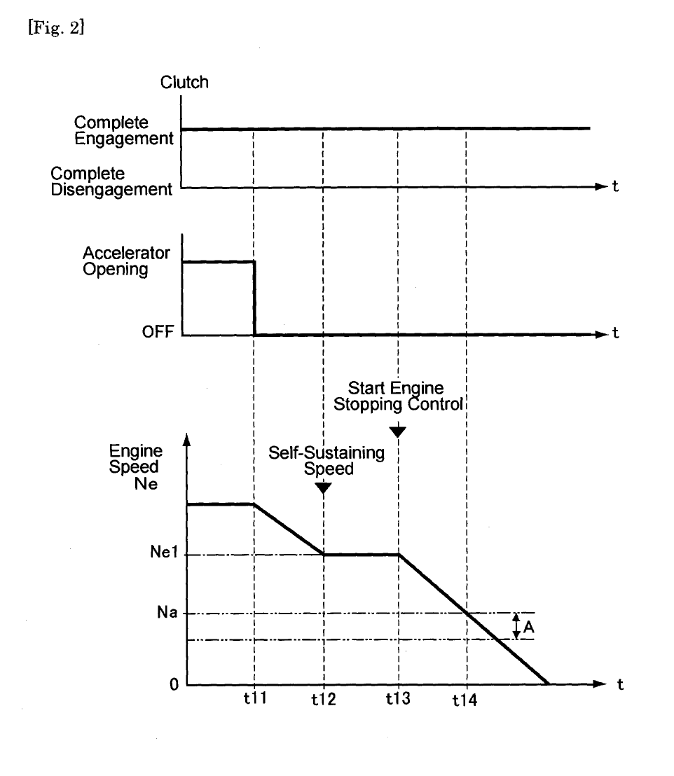

The resonance range A will be explained with reference to FIG. 2. In the time chart shown in FIG. 2, the hybrid vehicle Ve is propelled under the HV mode and the accelerator is closed at point t11 by returning the accelerator pedal. After point t11, fuel supply to the engine 1 or ignition of the engine 1 is stopped and hence the engine speed Nₑ starts lowering. Then, at point t12, the engine speed Ne is kept to a self-sustaining speed (as will be called “the idling speed” hereinafter) Nₑ₋₁ by controlling the first motor 2, at which the engine 1 is allowed to rotate autonomously by supplying the fuel thereto.

Then, the engine stopping control is commenced at point t13, and eventually the engine speed Nₑ reaches an upper limit speed Nₐ of the resonance range A at point t14. After point t14, the engine speed Nₑ falls below the upper limit value Nₐ and enters into the resonance range A thereby causing resonance in the downstream of the engine 1. Specifically, the resonance range A exists between the engine speeds of approximately 200 to 400 rpm. That is, according to the preferred example, the aforementioned upper limit speed Nₐ of the resonance range A is set to 400 rpm. If the powertrain 100 is provided with a damper device, the resonance range A may be adjusted to a speed range where resonance occurs in the powertrains having the damper.

Accordingly, resonance will not occur during engagement of the clutch C if the s engine speed Nₑ is higher than the resonance range A. That is, the upper limit speed Nₐ corresponds to a lower limit value of the engine speed Nₑ or the input speed Nᵢₙ at which nvh (i.e., noise, vibration, and harshness) characteristics will not be worsened during engagement of the clutch C. Thus, the upper limit speed Nₐ of the resonance range A is determined taking account of the nvh characteristics. When the engine speed Nₑ enters into the resonance range A during engagement of the clutch C, the damper will resonate with the engine 1 to amplify vibrations in the downstream of the clutch C.

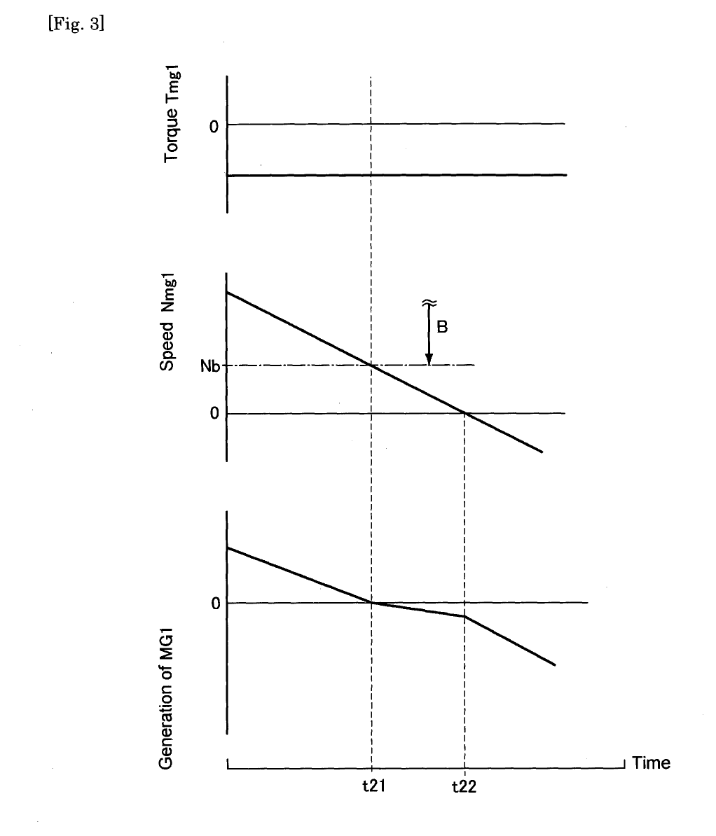

The generation range B will be explained with reference to FIG. 3. FIG. 3 is a time chart showing a status of the first motor 2 during execution of the lowering control of the engine speed Nₑ. In the situation shown in FIG. 3, the first motor 2 is rotated in the forward direction by an inertia torque of the engine 1 during engagement of the clutch C. That is, the first motor 2 establishes a negative torque to generate electricity.

When the first motor 2 generates electricity, a core loss (i.e., a switching loss) is caused inevitably. Especially, generating efficiency of the first motor 2 is worsened significantly by the core loss within the low speed range. During execution of the lowering control of the engine speed Nₑ, the first motor 2 generates electricity while consuming electricity. That is, when the speed N_{mg1} of the first motor 2 falls below the lower limit speed N_{b} of the generation region B at point t21, power consumption including such core loss exceeds a production of electricity.

Specifically, when the speed N_{mg1} of the first motor 2 falls below 800 rpm, an electricity will not be generated or an electrical loss will be caused. According to the preferred example, therefore, the lower limit speed N_{b} of the generation range B is set to 800 rpm.

That is, the power generation of the first motor 2 is larger than the power consumption thereof before point t21 when the speed N_{mg1} thereof falls within the generating range B. After point t22, the first motor 2 is rotated in the counter direction while establishing a negative torque without generating electricity.

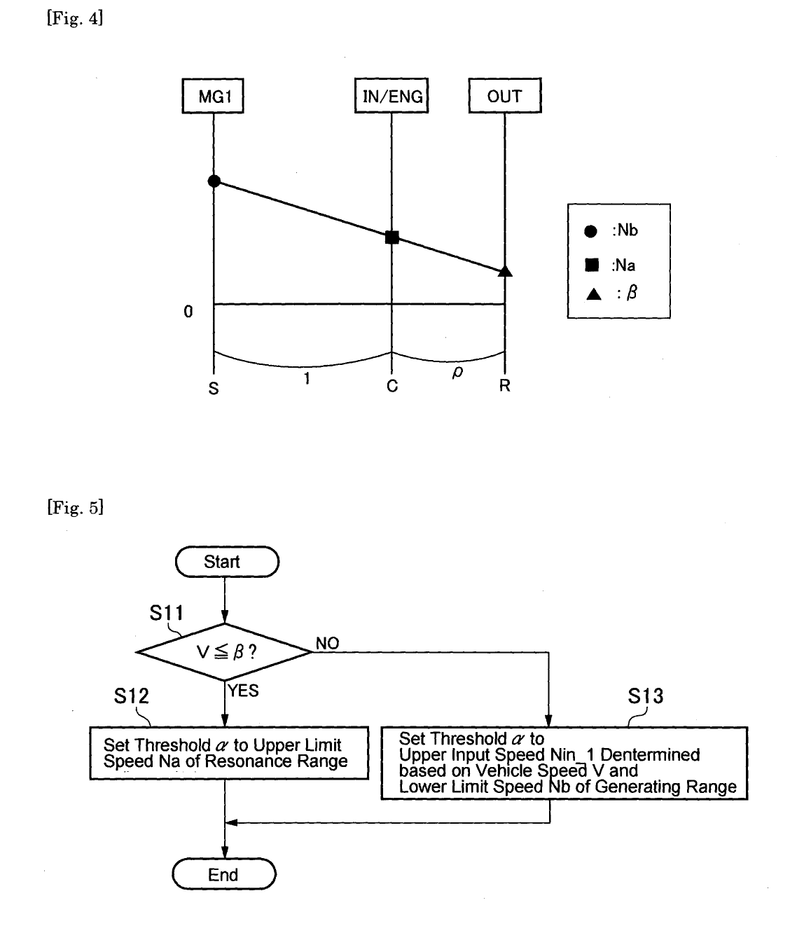

The aforementioned threshold β is determined based on the upper limit speed Nₐ of the resonance range A, the lower limit speed N_{b} of the generation range B, and the gear ratio ρ of the power distribution device 6. As described, the upper limit speed Nₐ is the input speed Nᵢₙ, the lower limit speed N_{b} is the speed N_{mg1} of the first motor 2, and the threshold β is the predetermined vehicle speed. Relations among those parameters are illustrated in FIG. 4 in the form of nomographic diagram. As can be seen from FIG. 4, the lower limit speed N_{b} of the generation range B, the upper limit speed Nₐ of the resonance range A, and an output speed used to determine the threshold β bear a proportionate relationship.

Specifically, the output speed is a speed of the output member including the ring gear 6r, the output shaft 7 and the output gear 8. That is, the threshold β can be calculated based on the speed of the ring gear 6r and the speed ratio between the ring gear 6r and the drive wheels 20. In FIG. 4, the threshold β thus determined is indicated on the vertical line of right side.

Procedures of determining the threshold α will be explained with reference to FIG. 5. At step S11, it is determined whether or not the vehicle speed V is equal to or lower than the threshold β.

If the vehicle speed V is equal to or lower than the threshold β so that the answer of step S11 is YES, the routine advances to step S12 to set the threshold α to the upper limit value Nₐ of the resonance range A.

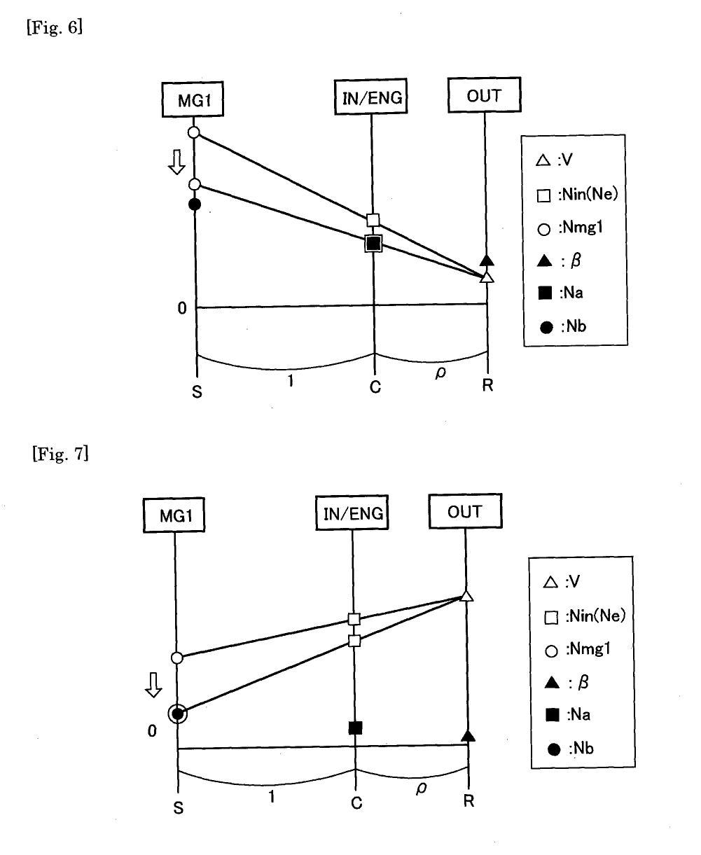

A situation of the case in which the answer of step S11 is YES is shown in FIG. 6. In this case, the vehicle speed V is lower than the threshold β, the speed N_{mg1} of the first motor 2 is higher than the lower limit speed N_{b}, and the engine speed Nₑ is higher than the upper limit speed Nₐ.

In this situation, if the lowering control of the vehicle speed Nₑ is carried out as indicated by an arrow in FIG. 6, the engine speed Nₑ is lowered to the upper limit speed Nₐ before the speed N_{mg1} of the first motor 2 reaches the lower limit speed N_{b}. As described, the threshold α is compared to the input speed Nᵢₙ. In this case, therefore, the threshold α is set to the upper limit value Nₐ of the resonance range A at step S12.

By contrast, if the vehicle speed V is higher than the threshold β so that the answer of step S11 is NO, the routine advances to step S13 to set the threshold α to an input speed Nᵢₙ₋₁ determined based on the vehicle speed V and the lower limit speed N_{b}.

A situation of the case in which the answer of step S11 is NO is shown in FIG. 7. In this case, the vehicle speed V is higher than the threshold β, the speed N_{mg1} of the first motor 2 is higher than the lower limit speed N_{b}, and the engine speed Nₑ is higher than the upper limit speed Nₐ.

If the lowering control of the vehicle speed Nₑ is carried out as indicated by an arrow in FIG. 7 under the condition where the engine speed Nₑ is higher than the threshold β, the speed N_{mg1} of the first motor 2 reaches the lower limit speed N_{b} before the engine speed Nₑ is lowered to the upper limit speed Nₐ. In this case, since the lower limit speed N_{b} is not a parameter to be compared to the input speed Nᵢₙ, the input speed Nᵢₙ₋₁ is prepared to be compared to the input speed Nᵢₙ.

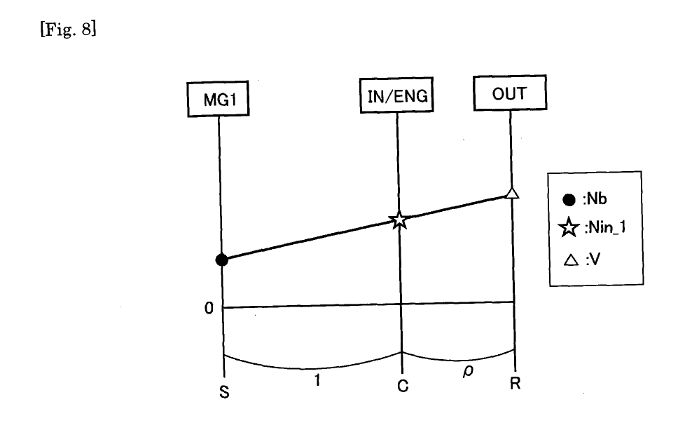

Specifically, the input speed Nᵢₙ₋₁ to be employed as the threshold α in case the vehicle speed V is higher than the threshold β is calculated based on the lower limit speed N_{b}, the vehicle speed V and the gear ratio ρ. As can be seen from the nomographic diagram shown in FIG. 8, the lower limit speed N_{b}, the input speed Nᵢₙ₋₁ and the vehicle speed V bear a proportionate relationship.

Thus, the threshold α is set to different values at steps S12 or S13 depending on the vehicle speed V, and then the routine shown in FIG. 5 is ended.

That is, the threshold α is set to the upper limit value Nₐ of the resonance range A, or to the value determined based on the lower limit speed N_{b} of the generating range B depending on the vehicle speed V. In other words, the threshold α is differentiated taking account of nvh characteristics and electric consumption.

As described, the threshold α is compared to the input speed Nᵢₙ at step S3 of the routine shown in FIG. 1 for the purpose of determining whether or not to bring the clutch C into disengagement and whether or not to interrupt power supply to the first motor 2.

According to the preferred example, therefore, the clutch C is allowed to be brought into disengagement before the input speed Nᵢₙ enters into the resonance range A when stopping the engine 1. For this reason, resonance will not be caused by vibrations of the engine 1 in the downstream of the clutch C. In addition, in case the answer of step S3 is YES, the first motor 2 is allowed to regenerate electricity during execution of the lowering control of the engine speed Nₑ until the speed N_{mg1} thereof is reduced to the lower limit speed N_{b} of the generation range B. Therefore, the battery 42 can be charged sufficiently, that is, shortage of electricity can be prevented so that the power distribution to the first motor 2 can be cut-off in many cases.

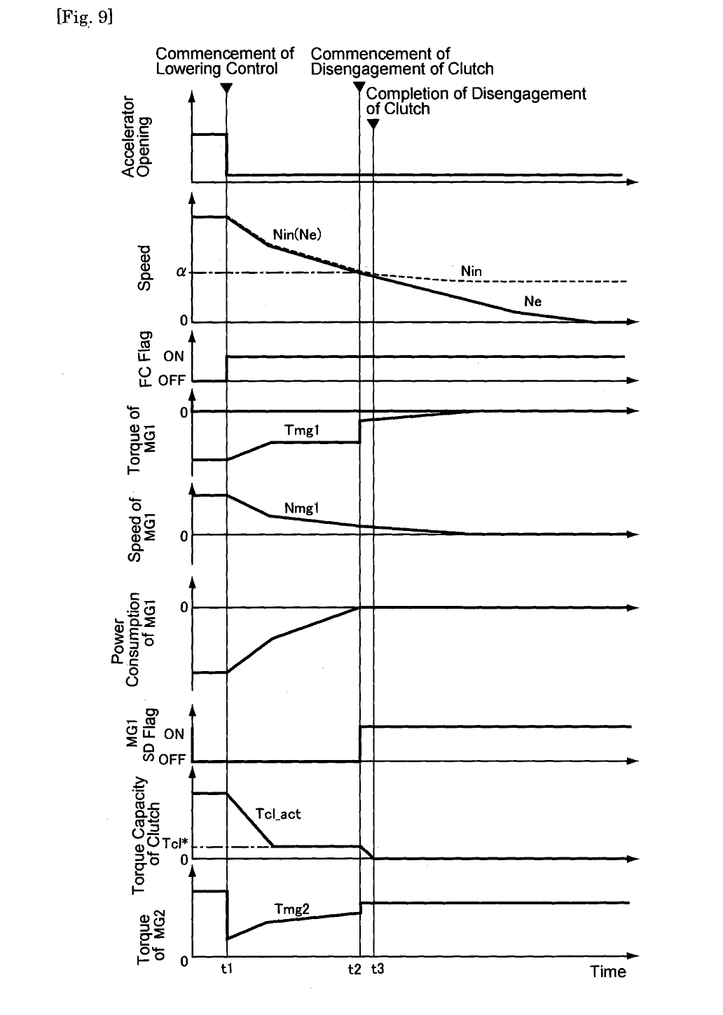

Referring now to FIG. 9, there is shown a time chart showing temporal changes in statuses of the hybrid vehicle Ve propelled under the HV mode during execution of the engine stopping control.

In the example shown in FIG. 9, the engine stopping control is commenced at point t1 upon satisfaction of the stopping condition. For example, the engine stopping control is commenced when the accelerator pedal is returned under the HV mode. At point t1, specifically, the fuel cut-off control, the lowering control of the engine speed Nₑ, and the torque control of the clutch C are started.

In this situation, an FC flag is turned to ON, and the negative torque T_{mg1} of the first motor 2 starts increasing. Consequently, the speed N_{mg1} of the first motor 2 rotating in the forward direction and the input speed Nᵢₙ start lowering. Since the speed Nₑ, of the first motor 2 is thus lowered during the lowering control of the engine speed Nₑ, generating amount of the first motor 2 is reduced. At the same time, the torque T_{mg2} of the second motor 3 is controlled in a manner such that shocks will not be caused by carrying out the engine stopping control.

In addition, since the torque control of the clutch C is started simultaneously with the lowering control of the engine speed Nₑ, the torque capacity T_{cl-act} also starts lowering from point t1 toward the target torque capacity T_{cl}′. That is, the engine 1 does not generate torque during execution of the fuel cut-off so that the required torque capacity of the clutch C is reduced. Therefore, the clutch C is allowed to reduce the torque capacity T_{cl-act} thereof from point t1.

Then, when the input speed Nᵢₙ being lowered falls below the threshold α, disengagement of the clutch C is commenced at point t2. Consequently, the torque capacity T_{cl-act} of the clutch C falls below the target torque capacity T_{cl}′ and hence the clutch C starts slipping. As a result, the input speed Nᵢₙ and the engine speed Nₑ start deviating from each other.

In addition, at point t2, power supply to the first motor 2 is stopped simultaneously with starting the disengagement of the clutch C. At point t2, specifically, the determination that the speed N_{mg1} of the first motor 2 is lower than the speed possible to stop the first motor 2 normally is satisfied so that the first motor 2 is stopped and an SD flag is turned to ON. Thus, according to the example shown in FIG. 9, the power supply to the first motor 2 is interrupted while bringing the clutch C into disengagement, during execution of the lowering control of the engine speed Nₑ.

Consequently, the first motor 2 stops to generate the torque T_{mg1} and electric consumption thereof is reduced to zero after point t2. That is, the generating amount of the first motor 2 exceeds the electric consumption thereof after point t2. Here, after point t2, only a cogging torque is generated by the first motor 2.

Then, the disengagement of the clutch C is completed at point t3. As described, the torque capacity T_{cl-act} of the clutch C is reduced to the target torque capacity T_{cl}′ in advance. Therefore, the clutch C is allowed to be brought into disengagement promptly without causing shocks. Consequently, a required time to bring the clutch into complete disengagement from point t2 to point t3 can be shortened.

That is, the vehicle is propelled under the HV mode from the point t1 to point t2. Then, the drive mode is shifted the first EV at point t2, and further shifted to the second EV mode at point t3.

Thus, according to the preferred example shown in FIG. 9, the power supply to the first motor 2 is stopped at point t2 simultaneously with starting the disengagement of the clutch C. However, the preferred example may be modified according to need.

For example, the power interruption to the first motor 2 may also be commenced at any timing during a period from the commencement of slippage of the clutch C to the completion of disengagement. Alternatively, the power interruption to the first motor 2 may also be commenced after the completion of disengagement of the clutch C.

Thus, according to the preferred example of the engine stopping system, the electric consumption of the first motor 2 can be reduced to zero when stopping the engine 1 automatically so that an energy loss resulting from stopping the engine 1 can be reduced.

It is to be understood that the engine stopping system according to the present invention is limited to the foregoing preferred example, but may be modified within the spirit and scope of the present invention.

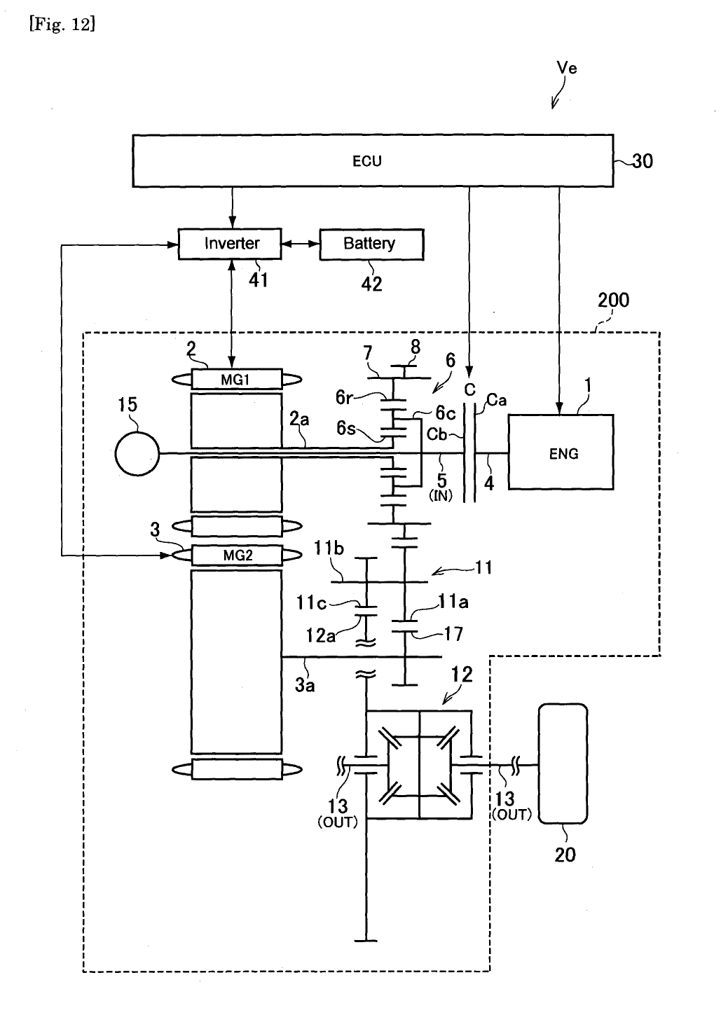

For example, the engine stopping system may be applied not only to the powertrain 100 shown in FIG. 10 but also to another powertrain shown in FIG. 12.

In the powertrain 200 shown in FIG. 12, a rotational axis of the second motor 3 extends parallel to those of the engine 1 and the first motor 2. In FIG. 12, common reference numerals are allotted to the elements in common with those in the example shown in FIG. 10, and detailed explanation for those common elements will be omitted.

In addition, the powertrain 200 is provided with a reduction gear 17. The reduction gear 17b is meshed with the counter driven gear 11a of the counter gear unit 11, and a diameter thereof is smaller than that of the counter driven gear 11a. Therefore, torque of the second motor 3 is delivered to the drive wheels 20 while being multiplied.

1. An engine stopping system that is applied to a hybrid vehicle (Ve) comprising:
an engine;
a motor having generating function;
a clutch that selectively connects and disconnects the engine to/from the power distribution device;
wherein the power distribution device performs a differential action among a first rotary element joined to the motor to be rotated integrally therewith, a second rotary element joined to the engine through the clutch, and a third rotary element functioning as an output element to deliver torque to drive wheels; and
wherein the engine stopping system is configured to vary an engine speed by controlling a torque of the motor during engagement of the clutch; and
wherein the engine stopping system is configured to interrupt power supply to the motor while bringing the clutch into disengagement, when the engine speed falls below a predetermined threshold value greater than zero, under conditions that the engine does not generate power during engagement of the clutch, and that the motor generates electricity utilizing an inertia torque of the engine while controlling an output torque of the motor in a manner such that the engine speed is lowered.

2. The engine stopping system as claimed in claim 1,
wherein the threshold value of the engine speed is set to a value calculated based on a vehicle speed and a lower limit speed of a speed range of the motor where a generation amount of the motor exceeds an electric consumption to generate electricity, in case the vehicle speed is higher than a predetermined speed and the motor is rotated in a same direction as a rotational direction of the engine; and
wherein the lower limit speed is set to a value greater than zero.

3. The engine stopping system as claimed in claim 1, wherein the threshold value of the engine speed is set to an upper limit value of a speed range of the engine where the engine resonates with a powertrain, in case the vehicle speed is lower than the predetermined speed.

4. The engine stopping system as claimed in claim 1,
wherein the clutch includes a friction clutch; and
wherein the engine stopping system is further configured to reduce a torque capacity of the clutch to an extent not to cause a slippage of the clutch, before the engine speed falls below the threshold value under conditions that the engine does not generate power during engagement of the clutch.

5. The engine stopping system as claimed in claim 4, wherein the engine stopping system is further configured to interrupt the power supply to the motor after the clutch starts slipping.

6. The engine stopping system as claimed in claim 4, wherein the engine stopping system is further configured to interrupt the power supply to the motor simultaneously with bringing the clutch into disengagement.
